(19) United States
(12) Patent Application Publication
(10) Pub. No.: US 2009/0034737 A1
(43) Pub. Date: Feb. 5, 2009

(54) Diamond nanocrystal single-photon source with wavelength converter

(75) Inventor: Alexei Trifonov, Boston, MA (US)

Correspondence Address: OPTICUS IP LAW, PLLC, 7791 ALISTER MACKENZIE DRIVE, SARASOTA, FL, 34240, US

(73) Assignee: MAGIQ TECHNOLOGIES, INC.

(21) Appl. No.: 11/881,972

(22) Filed: Jul. 30, 2007

(51) Int. Cl. H04L 9/08; H04L 9/22

(52) U.S. Cl. 380/278; 380/46

(57) ABSTRACT

A single-photon source (SPS) (10) adapted to output single-photons (P3) at telecommunication wavelengths is disclosed. The SPS includes a color-centered diamond-nanocrystal (CCDN) single-photon source (SPS) (20) adapted to emit input photons (P1) having a wavelength A₁ that lies outside of the main telecommunication wavelength bands. A non-linear optical medium (50) pumped using pump photons (P2) of wavelength A₂ receives the input photons and optically downconverts them to output photons (P3) having a wavelength λ₃>λ₁ wherein λ₃ is within a telecommunication wavelength band. An optical filter (60) arranged downstream of the non-linear optical medium substantially blocks the pump photons (P2) while allowing for the transmission of the output photons. A QKD system that uses the SPS source of the present invention is also disclosed.

### FIELD OF THE INVENTION

The present invention relates generally to single-photon sources, and in particular to a diamond nanocrystal single-photon source having a wavelength converter.

### BACKGROUND ART

Single-photon light sources are finding increasing use for a variety of applications, including quantum computing and quantum communications. Most present-day quantum communication applications rely on weak coherent pulses (WCPs) formed by attenuating multi-photon light pulses so that the WCPs have, on average, less than one photon per pulse. However, this implies that, on average, some WCPs will have more than one photon per pulse, which diminishes the quantum security or quantum computing efficacy provided by true single-photon pulses. Accordingly, true single-photon light sources are often preferred, and in fact have been shown to provide greater transmission distance for quantum communication systems as compared to WCP-based systems.

A number of different types of single-photon sources have been developed based on the emission properties of single molecules, atoms, color centers, and semiconductor structures, such as quantum dots. Of these different single-photon sources, diamond nanocrystals having a “color center,” such as nitrogen vacancy (“NV”) or a nickel center (NE8), offer several key advantages for quantum communication and quantum computing applications.

One key advantage is that a color-centered diamond nanocrystal can emit single photons at room temperature. Another key advantage is that single-photon emission from a color-centered diamond nanocrystal avoids problems associated with the single-photon having to travel through a high-refractive-index material, which interferes with the clean transmission of the single photon. This is because color-centered diamond nanocrystals are sufficiently small so that refraction effects are insubstantial. Further, the small size of color-centered diamond nanocrystals (e.g., 10 to 100 nm) means that only a small volume of material needs to be pumped with a pump light source. This results in only very small amounts of background light from the pump light source. Other advantages include a low multi-photon probability and long coherence time.

Despite these advantages, a major problem with color-centered diamond nanocrystals as single-photon sources is the limited wavelength choices of the emitted photons, which is governed by the atomic-level structure of the color centers. This limits the suitability of color-centered diamond nanocrystals as single-photon sources for optical-fiber-based quantum computation and quantum telecommunication applications, such as quantum key distribution (QKD) and quantum memory devices, which operate best at the known telecommunication wavelengths.

### SUMMARY OF THE INVENTION

One aspect of the invention is a single-photon source. The source includes a color-centered diamond-nanocrystal (CCDN) single-photon source (SPS) adapted to emit input photons of wavelength λ₁. A non-linear optical medium is arranged to receive the input photons. A pump light source is in optical communication with the non-linear optical medium and is adapted to generate pump photons having a wavelength λ₂ that pump the non-linear optical medium so as allow the non-linear optical medium to optically downconvert said first photons passing through the non-linear optical medium to form output photons having a wavelength λ₃ longer than wavelength λ₁. An optical filter is arranged downstream of the non-linear optical medium and is adapted to substantially block the pump photons and to substantially transmit said output photons.

Another aspect of the invention is a method of generating single photons. The method includes generating input photons having a wavelength λ₁ using a color-center diamond nanocrystal (CCDN) single-photon source. The method also includes inputting the input photons into a non-linear optical material that is pumped so as to downconvert the input photons. The method further includes forming from the downconvert input photons output photons having an output wavelength λ₃.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

Whenever possible, the same reference numbers or letters are used throughout the drawings to refer to the same or like parts.

### BRIEF DESCRIPTION OF THE DRAWINGS

FIG. 1 is schematic diagram of an example embodiment of the color-centered diamond nanocrystal (CCDN) single-photon source (SPS) according present invention;

FIG. 2 is a detailed schematic diagram of the CCDN SPS of FIG. 1; and

FIG. 3 is a detailed schematic diagram of an example non-linear optical medium of the CCDN SPS of FIG. 1; and

FIG. 4 is a schematic diagram of a QKD system that employs the CCDN SPS of FIG. 1.

### DETAILED DESCRIPTION OF THE PREFERRED EMBODIMENTS

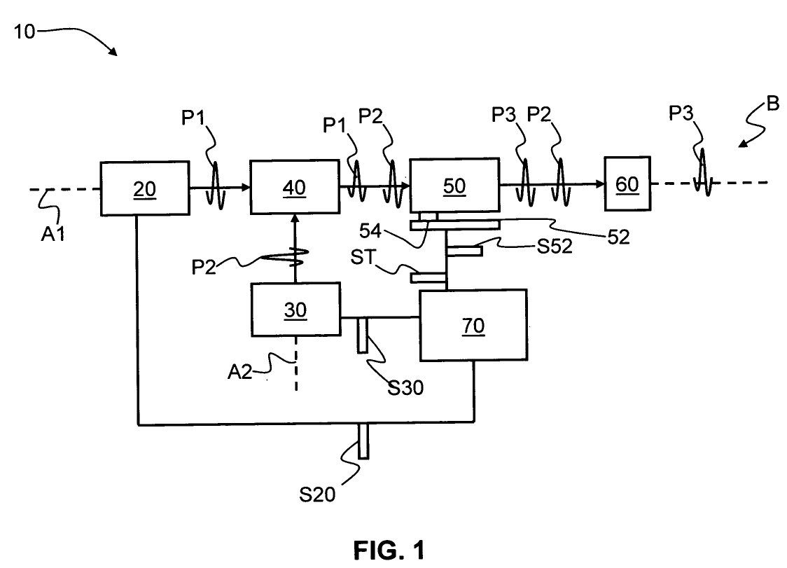

FIG. 1 is schematic diagram of an example embodiment of a single-photon source (SPS) 10 according to the present invention. SPS 10 includes an optical axis A1. Arranged along optical axis A1 is a color-centered (e.g., NV or NE8) diamond nanocrystal (CCDN) SPS 20 that generates single photons P1 having a wavelength λ₁. Single photons P1 are referred to herein as “input photons” for reasons that will become apparent from the discussion below. In an example embodiment, input photons P1 from the NV center have a wavelength λ₁˜637 nm.

SPS 10 further includes a pump light source 30 arranged along a second optical axis A2 that intersects optical axis A1. Pump light source 30 emits pump light (photons) P2 at a wavelength λ₂. In an example embodiment, λ₂˜1080 nm. Other pump wavelengths may be used depending on the input photon wavelength λ₁ and the output photon wavelength λ₃, as explained below. In an example embodiment, pump light source 30 is or includes a Nd:YAG laser, a GaAs laser diode, an InGaAsP laser diode, or the like.

SPS 10 includes at the intersection of axes A1 and A2 a multiplexing element 40 that multiplexes input photons P1 and pump photons P2 so that they travel in the same direction along optical axis A1.

SPS 10 further includes along optical axis A1 and optically downstream of multiplexing element 40 a non-linear optical medium 50, such as a non-linear bulk crystal or a periodically poled waveguide (including an optical fiber waveguide). Non-linear optical medium 50 is adapted to be pumped by photons P2 and perform frequency downconversion on photons P1 that are inputted into the non-linear optical medium-hence the use of the phrase “input photons” for photons P1. Non-linear optical medium 50 is adapted to perform downconversion on input photons P1 and generate downconverted output photons P3 having a wavelength λ₃. Described herein is a downconversion interaction based on three-wave mixing, but other conversion schemes, such as a four-wave mixing conversion scheme, can be used as well.

In an example embodiment, SPS 10 also includes a temperature control unit 52 in thermal communication with non-linear optical medium 50 to control the temperature of the non-linear optical medium. In an example embodiment, a temperature sensor 54 is also provided in thermal communication with the non-linear optical medium to measure its temperature and provide a corresponding temperature signal ST.

When pumping non-linear optical medium 50 with pump photons P2, some pump photons travel all the way through the non-linear optical medium and exit the other side. Accordingly, SPS 10 also includes a filter 60 adapted to substantially filter out the pump photons of wavelength λ₂ so that substantially only downconverted output photons P3 of wavelength λ₃ are emitted by SPS 10 as an output beam B.

SPS 10 also includes a controller 70 operably coupled to CCDN SPS 20, to pump light source 30, and to temperature control unit 52. Controller 70 is adapted (e.g., programmed) to coordinate and controls the operation of these elements via respective control signals S20, S30 and S52 to control the overall operation of SPS 10. For example, controller 70 synchronizes the operation of pump light source 30 so that it pumps non-linear optical medium 50 prior to input photons P1 arriving at the non-linear optical medium. Controller 70 is also adapted to receive temperature signal ST from temperature sensor 54 and process this signal so as to control the temperature of non-linear optical medium 50 via control signal S52.

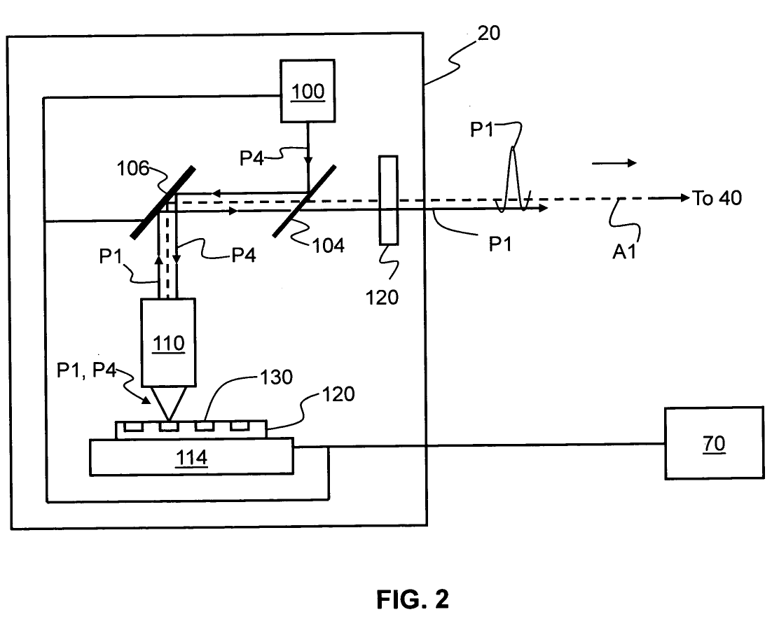

FIG. 2 is a detailed schematic diagram of an example embodiment of a CCDN SPS 20 of FIG. 1 that follows the work of Jean-Francois Roch et al., as described in the article www.physique.ens-chachan.fr/franges_photon/single_photon_source.htm (hereinafter, “the Roch article”), which article is incorporated by reference herein. In the description of CCDN SPS 20 associated with FIG. 2, both light rays and photons are used for the sake of convenience to describe and show the various light (photon) paths. With reference to FIG. 2, CCDN SPS 20 includes a pump light source 100 that generates pump light (photons) P4 of λ₄. In an example embodiment, λ₄=1008 nm for NV color centers

CCDN SPS 20 further includes a dichroic mirror 104 arranged along optical axis A1 in the optical path of pump photons P4. Dichroic mirror 104 is adapted to reflect pump photons P4 so that they travel along optical axis A1 to a scanning mirror 106, which serves to fold optical axis A1. Dichroic mirror 104 is also designed to pass light of wavelength λ₁. A high-numerical-aperture (NA) object lens 110 is arranged along the folded optical axis A1 so as to receive pump light P4 from scanning mirror 106.

SPS 20 includes a movable stage 114 that supports a substrate 120 that includes color-centered diamond nanocrystals 130 formed therein or thereupon as described in the Roch article.

The pulsed pump light P4 is focused by objective lens 110 onto the particular color-centered diamond nanocrystals 130 as determined by the position of movable stage 114 and scanning mirror 106. The energy in the pump light pulses is selected to ensure that the defect center in the irradiated nanocrystal 130 is pumped efficiently. In an example embodiment, single photons P1 having a wavelength λ₁ centered at about 637 nm are then emitted by NV color-centered diamond nanocrystal 130 at a rate proportional to the repetition rate of pump light source 110. Likewise, single photons P1 having a wavelength λ₁ centered about 800 nm are emitted by NE8 color-centered diamond nanocrystal 130 at a rate proportional to the repetition rate of pump light source 110. Single photons P1 are collected by objective lens 110, reflected by scanning mirror 106 and then pass through dichroic mirror 104. Single photons P1 then travel through a filter 120 that substantially blocks pump photons P4 of wavelength λ₄, thereby becoming “input photons” of wavelength λ₁.

As discussed above, controller 70 is adapted to coordinate and control the operation of SPS 20 via control signals S20 that travel to pump light source 100, movable stage 114, and scanning mirror 106.

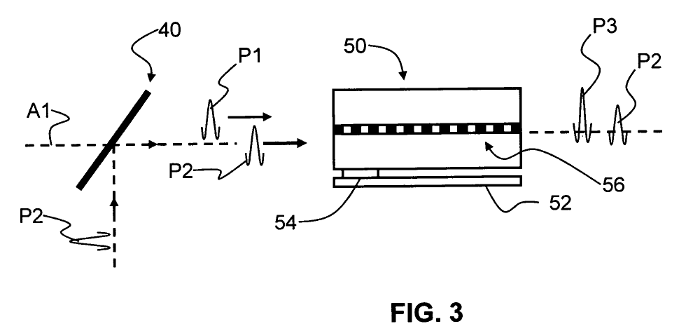

FIG. 3 is a close up schematic diagram of an example embodiment of non-linear optical medium 50 that is or otherwise includes a periodically poled (PPL) waveguide 56, such as formed from lithium niobate (PPLN). PPLN waveguides suitable for use in the present invention are commercially available from a number of vendors such as HC Photonics, Inc., and Thorlabs, Inc.

FIG. 3 also shows an example embodiment of multiplexer 40 that includes a dichroic mirror 42 adapted to pass light of wavelength λ₁ from SPS source 20 traveling along optical axis A1, and to reflect pump light of wavelength λ₂ that initially travels along optical axis A2 so that it travels along optical axis A1 toward non-linear optical medium 50.

In an example embodiment, pump wavelength λ₂ is selected according to the relationship 1/λ₂=(1/λ₁)−(1/λ₃). In an example embodiment, output wavelength λ₃ Of SPS source 10 is within one of the known telecommunication wavelength bands, such as in the O-band, E-band, S-band, C-band , L-band or U-band. In a specific example embodiment, λ₃ is one of the minimum optical fiber attenuation wavelengths of 1550 nm or 1310 nm.

Table 1 below summarizes the different wavelengths for an NV CCDN SPS source 20 and a NE8 CCDN SPS source for λ₃=1550 nm and 1310 nm.

TABLE 1
Wavelength Table

| | λ₁ | λ₂ | λ₃ |
|---|---|---|---|
| NV | 637 nm | 1080 nm | 1550 nm |
| NV | 690 nm | 1244 nm | 1550 nm |
| NE8 | 800 nm | 1653 nm | 1550 nm |
| NV | 637 nm | 1310 nm | 1310 nm |
| NV | 690 nm | 1458 nm | 1310 nm |
| NE8 | 800 nm | 2055 nm | 1310 nm |

QKD System with CCDN SPS

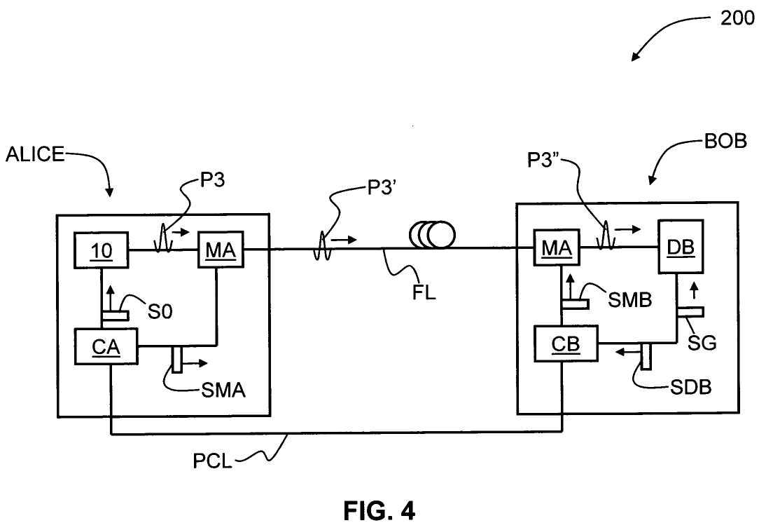

FIG. 4 is a schematic diagram of a generalized QKD system 200 that includes CCDN SPS 10. QKD system includes a first QKD station ALICE and a second QKD station BOB optically coupled by an optical fiber link FL. ALICE includes as a light source CCDN SPS 10 as described above. Alice also includes a modulator MA (e.g., a phase or polarization modulator) optically coupled to CCDN SPS 10 as well as to optical fiber link FL.

ALICE also includes a controller CA adapted to coordinate the operation of CCDN SPS 10 to emit output photons P3 in response to a control signal SO. Controller CA also times the operation of modulator MA via a modulator control signal SMA to modulate the output photons based on randomly selecting a modulation from a set of basis modulations according to the particular QKD protocol. For the sake of convenience, this process is referred to herein as selective random modulation. The result is the formation of once-modulated quantum signals P3′ that enter optical fiber link FL and travel over to BOB.

BOB includes a modulator MB (again, a phase or polarization modulator) optically coupled to optical fiber link FL, and a single-photon-detector (SPD) unit DB optically coupled to the modulator. BOB also includes a controller CB adapted to time the activation of modulator MB via a modulator control signal SMB to the arrival of once-modulated quantum signal P3′ to form twice-modulated quantum signal P3″. The modulation at BOB, like that at ALICE, is also based on selective random modulation. Controller CB also gates SPD unit DB via a detector gating signal SG to the expected arrival time of the twice-modulated quantum signal. SPD unit DB detects the twice-modulated signal and is adapted to discern the overall imparted phase (e.g., via constructive or destructive interference as detected in respective SPDs in the SPD unit) and provides the result to controller CB via a detector measurement signal SDB.

Controllers CA and CB are adapted to communicate with one another (e.g., over optical fiber link FL or a separate public communication link PCL) to synchronize the overall operation of QKD system 200, and to perform the QKD procedures. The QKD procedures generally include (publicly) comparing the modulations (i.e., basis and bit values associated with the selective random modulation) to establish a raw key, performing sifting to arrive at a sifted key, performing error correction to arrive at an error-corrected key, and performing privacy amplification to arrive at a privacy-amplified key, as described in the book by Bouwmeester et al., “The Physics of Quantum Information,” Springer-Verlag (2001), in Chapter 2, which Chapter is incorporated by reference herein.

QKD system 200 has the advantage that CCDN SPS source 10 provides a reliable, on-demand source of single-photons at a wavelength λ₃ suitable for use for long-distance QKD, such as λ₃=1310 nm or 1550 nm.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A single-photon source, comprising:
a color-centered diamond-nanocrystal (CCDN) single-photon source (SPS) adapted to emit input photons of wavelength λ₁;
a non-linear optical medium arranged to receive the input photons;
a pump light source in optical communication with the non-linear optical medium and adapted to generate pump photons having a wavelength λ₂ that pump the non-linear optical medium so as allow the non-linear optical medium to optically downconvert said first photons passing through the non-linear optical medium to form output photons having a wavelength λ₃; and
an optical filter arranged downstream of the non-linear optical medium and adapted to substantially block the pump photons and to substantially transmit said output photons.

2. The single-photon source of claim 1, wherein the non-linear optical medium is a periodically poled lithium niobate waveguide.

3. The single-photon source, wherein λ₁˜637 nm, λ₂˜1080 nm and λ₃˜1550 nm.

4. The single-photon source, wherein λ₁˜637 nm, λ₂˜1310 nm and λ3˜1310 nm.

5. The single-photon source of claim 1, wherein the CCDN includes one of either a nitrogen vacancy (NV) or a nickel center (NE8).

6. A quantum key distribution (QKD) system, comprising:
a first QKD station having the SPS of claim 1 and adapted to generate once-selectively-randomly-modulated quantum signals from the output photons;
a second QKD station optically coupled to the first QKD station and adapted to receive and selectively randomly modulate the once-selectively-randomly modulated quantum signals so as to form twice-selectively-randomly modulated quantum signals and detect same in a manner that provides information about the overall modulation imparted to the twice-selectively-randomly-modulated quantum signals; and
wherein the first and second QKD stations are adapted to create a common key based on the exchanged quantum signals.

7. A method of generating single photons, comprising:
generating input photons having a wavelength λ₁ using a color-center diamond nanocrystal (CCDN) single-photon source;
inputting the input photons into a non-linear optical material that is pumped so as to downconvert the input photons; and
forming from the downconverted input photons output photons having an output wavelength λ₃.

8. The method of claim 7, wherein the input photon wavelength λ₁ is outside of a telecommunication wavelength band, and wherein the output photon wavelength λ₃ is within a telecommunication wavelength band.

9. The method of claim 7, including forming the input photons so that the input photon wavelength λ₁ is ˜637 nm and pumping the non-linear optical medium so that the output photon wavelength λ₃ is either ˜1550 nm or ˜1310 nm.

10. The method of claim 7, including providing a periodically poled non-linear waveguide for the non-linear optical medium.

11. The method of claim 7, including:
pumping the non-linear optical medium with pump photons of wavelength λ₂.

11. The method according to claim 10, including filtering out pump photons that exit the non-linear optical medium so that substantially only output photons in an output beam.

12. A method of forming a quantum key, comprising:
forming output photons according to the method of claim 7 at a first QKD station ALICE;
selectively randomly modulating the output photons to form once-modulated quantum signals;
transmitting the once-modulated quantum signals to a second QKD station BOB;
at BOB, selectively randomly modulating the once-modulated quantum signals so as to form twice-modulated quantum signals;
detecting the twice modulated quantum signals so as to determine an overall phase imparted thereto; and
communicating between BOB and ALICE information concerning the modulation and detection of the quantum signals so as to form the quantum key.
